(19) United States
(12) Patent Application Publication
(10) Pub. No.: US 2014/0236749 A1
(43) Pub. Date: Aug. 21, 2014

(54) APPLYING CUSTOMER FEEDBACK TO GROUP BUYING DEALS

(71) Applicant: YAHOO| INC., SUNNYVALE, CA (US)

(72) Inventor: Shengwen Yang, Beijing (CN)

(73) Assignee: YAHOO! INC., SUNNYVALE, CA (US)

(21) Appl. No.: 13/810,845

(22) PCT Filed: Nov. 2, 2011
(86) PCT No.: PCT/CN11/01850

§ 371 Date: Jan. 17, 2013

(51) Int. Cl. G06Q 30/02; G06Q 30/06

(52) U.S. Cl. CPC G06Q 30/0282; G06Q 30/0605
USPC 705/26.2

(57) ABSTRACT

A system and method for ensuring the quality of a group buying experience includes: receiving a request to sell a product; negotiating a service level agreement with the business; receiving customer feedback on the group buying experience; computing a customer satisfaction score for the group buying experience representing a degree of customer satisfaction; mapping the computed customer satisfaction score to terms in the service level agreement; and providing an instruction related to the customer satisfaction score.

### CROSS-REFERENCE TO RELATED APPLICATIONS

This application is a national phase entry of PCT/CN2011/001850. This application claims the benefit and priority of and to PCT/CN2011/001850, with a priority date of Nov. 2, 2011.

### STATEMENT REGARDING FEDERALLY SPONSORED-RESEARCH OR DEVELOPMENT

None.

### INCORPORATION BY REFERENCE OF MATERIAL SUBMITTED ON A COMPACT DISC

None.

### FIELD OF THE INVENTION

The invention disclosed broadly relates to the field of Internet Services, and more particularly relates to the field of group buying on the Internet.

### BACKGROUND OF THE INVENTION

The past several years have witnessed a boom in group buying websites. Group-buying services are a booming Internet service, which has already produced a market of billions of dollars each year and is still expanding very rapidly. Millions of people are making purchases with great discounts through these shopping websites. Group buying can be seen as a new kind of online advertising or promotion method, supplementary to the traditional Internet advertising methods (such as paid search and display ad). As compared with paid search or display ad, the group buying service is particularly useful for and welcomed by local small and medium businesses. The leading group buying websites like Groupon and LivingSocial make billions of dollars every year with revenues increasing at a fast rate.

A group buying deal generally involves three parties. These parties are: 1) businesses (sellers); 2) customers (buyers); and 3) service providers or trading platforms (i.e., group buying websites). In a typical case, a business agrees to offer a product or service at a heavily discounted price; the deal is then announced by a trading platform via its website, third-party social media, or other communication channels; and a customer who receives the announcement may decide to take the deal. Typically, the deal will go into effect if the number of customers deciding to take the deal exceeds a predefined minimum number, as in Groupon, where the deal is considered “tipped” when the number of prospective buyers reaches a minimum. Once a deal is “tipped” the bargain price is offered (generally at a deep discount).

All three parties can benefit from a good group buying deal. The customers receive a product or service at a very low price, thus saving money. The trading platforms benefit from a commission offsetting a percentage of the seller's sales revenue. The business promotes its products or services and increases sales from returning customers.

In a group buying scenario, there exists a strong incentive to offer good bargains. Bad deals can hurt all parties involved. All three parties can be jeopardized as a result of a bad deal: the customers receives low-quality products or services; the trading platform acquires a bad reputation because of false advertising and ultimately loses customers; and the business damages its reputation and can lose existing customers. In most cases, a business will deliver the same-quality product or service delivered to full-price customers to its group buying customers, and achieve a triple win.

However, in spite of the strong incentive to offer good deals, some bad deals are offered. The reasons are various. For one example, a business may underestimate the power of group buying and get acquire more initial customers than it can service. In this case, the business may unintentionally alienate these new customers. For another example, a business may underestimate the negative impact of unsatisfactory group-buying customers to its reputation and fail to adequately regulate their quality control, thereby delivering a low-quality product or service. And in an extreme case, the trading platform may be maliciously utilized by swindlers in order to cheat customers.

The group buying phenomenon is still in a growth stage, spreading quickly to take up market share. As yet, there are no reliable methods in place to ensure the sustainable development of the group buying market. Thus, there is a need for a system and method to address the sustainability and consumer satisfaction of group buying sites.

### SUMMARY OF THE INVENTION

This invention recognizes that the customer satisfaction is essential to a successful group buying market and introduces a method for guaranteeing and improving user satisfaction with group-buying deals. The method and mechanisms disclosed in this invention are very useful for boosting the sustainable development of the group buying business.

Briefly, according to an embodiment of the invention a method includes steps or acts of: receiving a request to sell a product; negotiating a service level agreement with the business; receiving customer feedback on the group buying experience; computing a customer satisfaction score for the group buying experience representing a degree of customer satisfaction; mapping the computed customer satisfaction score to terms in the service level agreement; and providing an instruction related to the customer satisfaction score.

According to another embodiment of the present invention, a system for performing group purchase transactions includes: an information processor configured for implementing the method of ensuring the quality of a group buying experience.

According to another embodiment of the present invention, a computer program product includes computer-executable instructions that enable a computer to perform the method steps of ensuring the quality of a group buying experience.

The method can also be implemented as machine executable instructions executed by a programmable information processing system or as hard coded logic in a specialized computing apparatus such as an application-specific integrated circuit (ASIC).

### BRIEF DESCRIPTION OF THE SEVERAL VIEWS OF THE DRAWINGS

To describe the foregoing and other exemplary purposes, aspects, and advantages, we use the following detailed description of an exemplary embodiment of the invention with reference to the drawings, in which:

FIG. 1 is a high level block diagram showing an information processing system configured to operate according to an embodiment of the present invention; and

FIG. 2 is a simplified depiction of the process flow among the three entities involved in a group buying scenario, according to an embodiment of the present invention;

FIG. 3 is a flowchart of a method according to another embodiment of the invention; and

FIG. 4 shows a mapping between an SLA and a customer feedback survey.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

Before describing in detail embodiments that are in accordance with the present invention, it should be observed that the embodiments reside primarily in combinations of method steps and system components related to systems and methods for placing computation inside a communication network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

We describe a solution to address the inadequacies of the group buying scenario, as presented earlier. Our solution puts a mechanism in place to guarantee and/or improve the quality of group buying deals. With such mechanisms, the benefits of all three parties involved in a group buying deal are protected, which are essential for building a healthy group-buying ecosystem and boosting the group-buying business.

### Advantages of the Invention

First, the method for improving the quality of group buying deals points out an important problem facing current group buying markets; namely, how to guarantee/improve customer satisfaction in online group buying. This is deemed to be essential to the sustainable development of the business.

Second, the method addresses the problem with a set of mechanisms to push the business to provide the best quality product or service for the group-buying customers, thus leading to a triple-win situation.

Third, the method emphasizes the protection of customers who benefit by leveraging a set of incentive and refund mechanisms. Satisfied customers are the foundation for a healthy group buying market.

Fourth, the method protects the benefit of good businesses by rewarding them with a lower commission and a higher payment. Meanwhile, the method builds a healthy market environment by penalizing bad deals and finally banning the bad businesses.

Fifth, the method also protects the benefit of the trading platform by ensuring the happiness of customers and businesses, which will bring more deals and users to the trading platform.

In our discussion of the method for guaranteeing and/or improving the quality of group buying deals, we initiate a reward and penalty mechanism for stimulating businesses to deliver high-quality products or services. The mechanism computes a degree of customer satisfaction based on customer reviews and feedback to a group buying deal. According to the computed degree of customer satisfaction, a reward or penalty to the business is applied. The method also involves an incentive mechanism for encouraging customers to provide feedback, as well as some other auxiliary mechanisms, which will be described in detail.

The system for improving the quality of group buying deals.

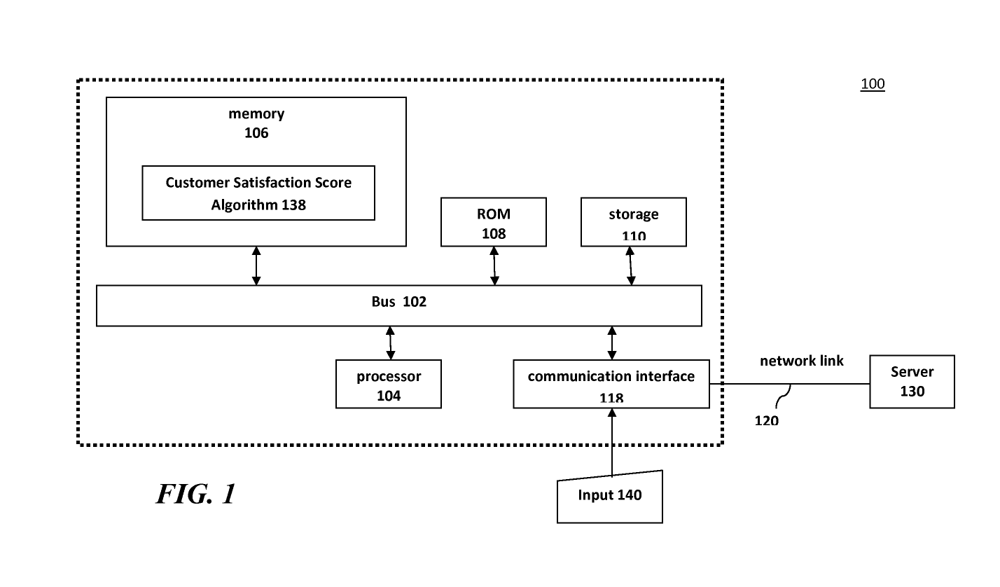

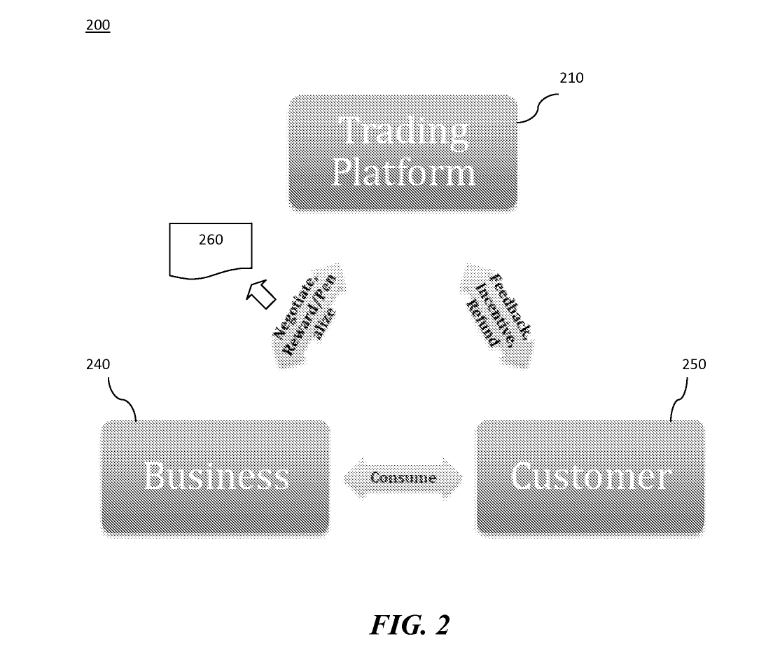

Referring now specifically to the drawings and to FIG. 1 in particular, there is shown a high-level block diagram illustrating an information processing system 100 upon which an embodiment of the present invention may be implemented. System 100 includes a bus 102 or other communication mechanism for communicating information, and one or more processors, such as processor device 104 coupled with bus 102 for processing information. System 100 also includes a main memory 106, such as a random access memory (RAM) or other dynamic storage device, coupled with bus 102 for storing information and instructions to be executed by processor device 104 for carrying out the steps in the flow chart of FIG. 2.

Memory 106 stores logic for performing the method steps discussed with respect to FIG. 2. Memory 106 can also store the algorithms 138 and computations for applying customer feedback and customer rewards.

Main memory 106 also may be used for storing temporary variables or other intermediate information during execution of instructions to be executed by process device 104. System 100 further includes, inter alia, a read only (ROM) memory 108 or other static storage device, coupled with bus 102 for storing static information and instructions for processor device 104. A storage device 110, such as a magnetic disk or optical disk, is provided and coupled with bus 102 for storing information and instructions.

In an embodiment of the present invention, computer system 100 is used for implementing the mechanisms for ensuring the quality of the group buying experience. According to one embodiment of the invention, the customer feedback validation is provided by system 100 in response to processor device 104 executing one or more sequences of one or more instructions contained in memory 106.

System 100 also includes a communication interface 118 providing a two-way communication coupling with a network link 120 for interoperability with a server or servers 130. Examples of a communications interface 118 may include a modem, a network interface (such as an Ethernet card), a communications port, a PCMCIA slot and card, etc. Software and data transferred via communications interface 118 are in the form of signals which may be, for example, electronic, electromagnetic, optical, or other signals capable of being received by communications interface 118. These signals are provided to communications interface 118 via a communications path (i.e., channel). The communications interface 118 further is enabled to receive input 140 (customer feedback) from the group buying customers. Input 140 such as customer feedback and the Service Level Agreement is received through the interface 118.

Network link 120 typically provides data communication through one or more networks to other devices. Network link 120 may provide a connection through a local network or to web browser providing access, through the Internet.

The group buying process flow.

The present invention will now be described with respect to FIGS. 2, 3, and 4 which are block diagrams and flowchart illustrations of embodiments of the present invention. It will be understood that each block of the flowchart illustrations and/or block diagrams, and combinations of blocks in the flowchart illustrations and/or block diagrams, can be implemented by computer program instructions.

FIG. 2 shows the process flow among the three main entities involved in a group buying paradigm. The Trading Platform 210 receives a request from the Business 240 to offer goods and/or services for sale on a group buying website. The Trading Platform 210 in turn negotiates with the Business 240 to set up guidelines for providing and delivering the goods and/or services offered for sale. The result of this negotiation is the Service Level Agreement 260. The Business 240 then sets up the group buying deal using the Trading Platform 210. Customers 250 view the group buying site and bid on and/or purchase the products offered for sale by the Business 240. Note that the term “product” as used herein can refer to both tangible goods (shoes, bicycles) and services (massages, haircuts).

The method for promoting a quality group buying experience.

The disclosed method includes:

1) a mechanism for negotiating a SLA (Service Level Agreement) between the business and the trading platform for a specific group buying deal;

2) a mechanism for customers to provide feedback about a group buying deal and a corresponding customer incentive mechanism;

3) a mechanism for computing the degree of customer satisfaction based on customer feedback;

4) a mechanism for rewarding/penalizing a business according to the negotiated SLA and the computed degree of customer satisfaction; and

5) a mechanism for refunding customers for low-quality deals.

In addition, the method according to an embodiment of the invention also includes the existing mechanisms for implementing group buying deals, e.g., for the business to publish a deal to the trading platform, and for the customer to buy a deal from the trading platform.

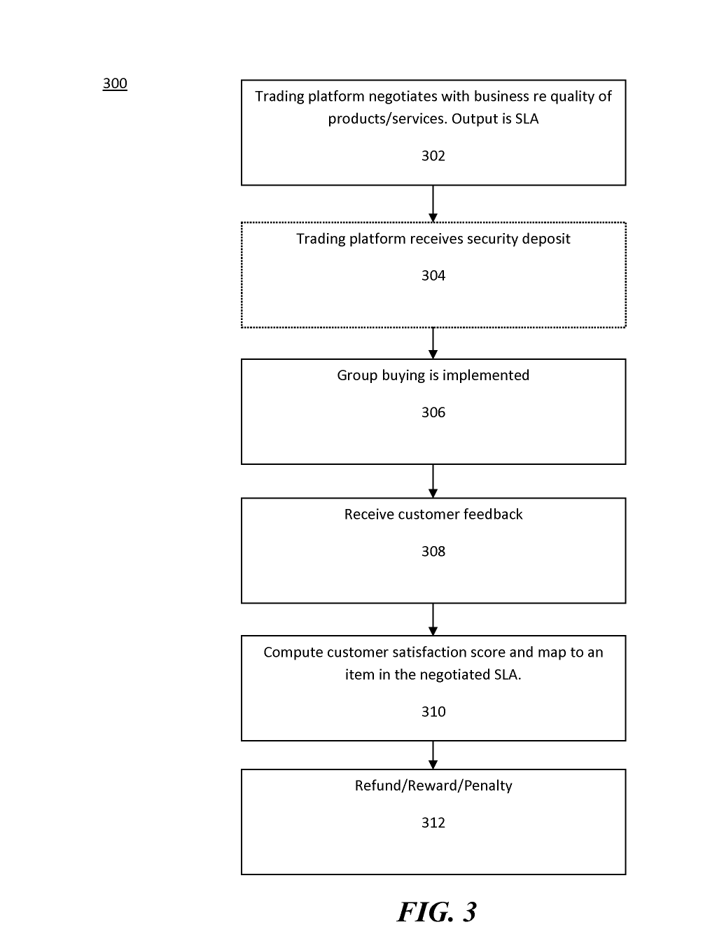

With reference now to FIG. 3 we show a flowchart 300 of an embodiment according to the present invention. The method steps described here are discussed from the point of view of the Trading Platform 210. The first step 302 involves negotiating the Service Level Agreement (SLA) 260. In this step, the Trading Platform 210 negotiates with the Business 240 concerning the quality of products or services to be delivered to Customers 250 in a group buying deal, resulting in an executed SLA 260. The purpose is to cause (or push) the Business 240 to deliver high-quality products or services to the group-buying Customers 250 and prevent unethical businesses from deceiving customers. Typically, the negotiated SLA 260 will specify the amount of payment that the Business 240 can ultimately receive from the group-buying deal according to different levels of quality. The higher the quality level, the more the payment.

The SLA 260 will also specify other terms and conditions of the sale. For example, the SLA 260 may disclose terms describing the expected quality of the product and/or the expected delivery of the product. For example, in a group buying deal where the Business 240 is a restaurant and the product is a discounted meal, the SLA 260 may mandate that the meal offered for sale on the Trading Platform 210 is expected to be of the same quality as the same meal served in the restaurant outside of the group buying deal. Things such as portion size and whether or not dessert is provided can be specified. Also, the SLA 260 may mandate the manner in which the product is delivered. This can involve the type of packaging for the product, whether or not the product is delivered assembled, and delivery fees.

Note that fees paid by group-buying Customers 250 are usually charged by the Trading Platform 210, and a portion of the fees is then transferred to the Business 240 according to a negotiated ratio. Under the guidance of the SLA 260, the Business 240 will try to deliver the best service in order to get a larger share of the payment. Because the Trading Platform 210 acts as an intermediary, it will refund Customers 250 a sum of money for low-quality or bad deals. In an optional step 304, the Trading Platform 210 may ask a Business 240 to pay a sum of guarantee money in order to prevent malicious deals, much like a security deposit is used today. The guarantee money may be a percentage of expected sales or some other amount negotiated between the Business 240 and the Trading Platform 210.

In step 306 the group buying program is implemented by the Trading Platform 210. The group buying program proceeds for a negotiated length of time at the negotiated terms. Next, in step 308 customer feedback is sought. The quality level of a deal is measured according to the feedback of Customers 250 who have participated in the deal. The customer feedback may include numerical ratings on various aspects of the group buying experience, and on the whole experience. The feedback may also include textual comments. Ideally the interface for the Customers 250 to provide the feedback is organized in such a manner that the negotiated terms of the SLA 260 are presented as interrogatories.

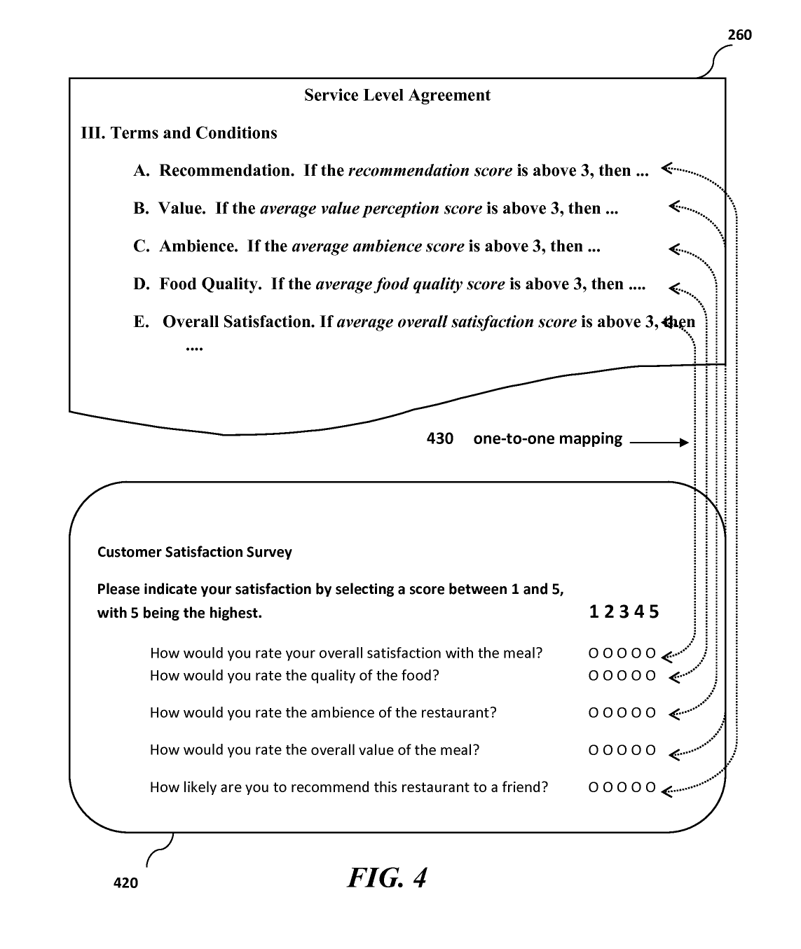

The customer feedback can be in various forms. For example, in a very simple case, a 5-star rating system can be used with each customer providing a rating between 1 (or zero) and 5 to reflect her/his overall satisfaction with the deal. See the customer satisfaction survey 420 of FIG. 4 reflecting a mapping 430 of the negotiated terms of the SLA 260. The average rating is then computed based on all feedback ratings. In a case where no feedback is received from some customers, a default rating is used in the average rating calculation. Because the customers who don't provide feedback are usually known to be happy customers, the default rating can be set to a large value, such as 4 or 5 out of 5. It should be noted that the customer satisfaction survey 420 of FIG. 4 is provided here as an example and to show one embodiment of a forum wherein Customers 250 are able to provide feedback on the group buying experience. The customer satisfaction survey can be implemented in different formats within the spirit and scope of the invention.

Correspondingly, the SLA 260 may contain negotiated terms mapped to customer satisfaction such as “if the average overall satisfaction score is above 4, the negotiated lowest commission rate will be applied,” or “if the average overall satisfaction score is below 2, the customers will be fully refunded and the security deposit will not be returned.” In this manner a customer satisfaction score can be easily mapped to a term in the SLA 260. Of course, more complicated customer feedback forms can be used in a real system and the terms in the SLA 260 can be more complicated to cover various fine-grained conditions. For example, besides the overall satisfaction rating, a Customer 250 can be asked to rate various aspects/features of the deal, e.g. food, ambience, service, and value for a restaurant deal. Correspondingly, a term in the SLA 260 can cover the average satisfaction score for the various aspects.

Customers 250 are not always willing to provide feedback. In order to encourage Customers 250 to provide feedback, a customer incentive may be offered. In order to stimulate Customers 250 to provide feedback, the Trading Platform 210 may provide some incentives to Customers 250 who provide feedback. The incentive may be electronic money (e-money), which can be used to purchase future deals, and/or a virtual symbol of reputation in the online customer community. Other incentives are contemplated within the spirit and scope of the invention.

Once the customer feedback from multiple Customers 250 has been received and aggregated, in step 310 the Trading Platform 210 performs a Customer Satisfaction Computation. According to the customer feedback, a customer satisfaction degree will be computed and mapped to an item in the negotiated SLA 260, which will be used to reward or penalize the Business 240. As not all the Customers 250 participate in providing feedback, and some dishonest Customers 250 may provide false feedback, the customer satisfaction computation may utilize some complicated methods in order to derive an accurate estimation of the actual customer satisfaction. Note that there may also exist a mechanism for the Business 240 to prove that the actual customer satisfaction should be higher than the estimated one. This may involve a third-party survey of a set of randomly sampled Customers 250 by some sophisticated statistical methods.

Lastly, in step 312 we apply rewards and penalties, as appropriate. The Business 240 can be rewarded or penalized according to the quality level of delivered service or product. The reward and penalty are typically fulfilled in the form of the final payment that is received by the Business 240. The higher the quality level, the greater the payment. Besides, the historical behaviors of a Business 240 will be recorded and visible to future Customers 250, which may have a heavy impact on the reputation of the Business 240.

Customer Refund: The Trading Platform 210 will refund the Customers 250 a sum of money for any low-quality or bad deals. The refund is usually less than or equal to what a customer has paid for the deal. In some cases, the Trading Platform 210 may refund a small sum of money additionally as a self-penalty for a bad deal to show its sincerity to customers.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, or RF.

Therefore, while there has been described what is presently considered to be the preferred embodiment, it will understood by those skilled in the art that other modifications can be made within the spirit of the invention. The above description(s) of embodiment(s) is not intended to be exhaustive or limiting in scope. The embodiment(s), as described, were chosen in order to explain the principles of the invention, show its practical application, and enable those with ordinary skill in the art to understand how to make and use the invention. It should be understood that the invention is not limited to the embodiment(s) described above, but rather should be interpreted within the full meaning and scope of the appended claims.

We claim:

1. A method ensuring a quality of a group buying experience, said method comprising:
using a processor device configured to perform:
receiving a request from a business to sell a product;
negotiating a service level agreement with the business, said service level agreement providing conditions of the sale of the product, said conditions comprising:
terms related to an expected level of quality of the product;
an expected level of efficiency in provision of the product; and
an amount of payment the business can ultimately receive from the sale of the product based on a reported level of quality;
receiving customer feedback on the group buying experience;
computing at least one customer satisfaction score for the group buying experience, wherein said customer satisfaction score represents a degree of customer satisfaction;
mapping the at least one customer satisfaction score to at least one term in the service level agreement; and
providing an instruction related to the customer satisfaction score.

2. The method of claim 1 further comprising a step of receiving a security deposit from the business as part of the service level agreement, said security deposit retained to provide a refund to a customer when necessary.

3. The method of claim 1 wherein providing the instruction comprises directing the business to provide a refund to the customer as a result of a low customer satisfaction score.

4. The method of claim 1 wherein providing the instruction comprises providing a reward to the business as a result of a high customer satisfaction score.

5. The method of claim 1 wherein providing the instruction comprises providing a penalty to the business as a result of a low customer satisfaction score.

6. The method of claim 1 further comprising providing an incentive for the customer to provide feedback.

7. The method of claim 1 further comprising providing an interface to customers wherein said customers provide feedback on the group buying experience.

8. The method of claim 7 wherein questions provided in the interface are mapped to terms in the service level agreement.

9. A system ensuring a quality of a group buying experience comprising:
a memory storing instructions;
a processor device operably coupled with the memory, said processor device configured to perform:
receiving a request from a business to sell a product;
negotiating a service level agreement with the business, said service level agreement providing conditions of the sale of the product, said conditions comprising:
terms related to an expected level of quality of the product;
an expected level of efficiency in provision of the product; and
an amount of payment the business can ultimately receive from the sale of the product based on a reported level of quality;
receiving customer feedback on the group buying experience;
computing at least one customer satisfaction score for the group buying experience, representing a degree of customer satisfaction;
mapping the at least one customer satisfaction score to at least one. term in the service level agreement; and
providing an instruction related to the customer satisfaction score.

10. The system of claim 9 further comprising:
an interface for customers to provide feedback on the group buying experience.

11. The system of claim 10 wherein questions provided in the interface are mapped to terms in the service level agreement.

12. The system of claim 9 wherein the processor device is further configured to receive a security deposit from de business as part of the service level agreement, said security deposit retained to provide a refund to a customer when necessary.

13. The system of claim 9 wherein providing the instruction comprises directing the business to provide a refund to the customer as a result of a low customer satisfaction score.

14. The system of claim 9 wherein providing the instruction comprises providing a reward to the business as a result of a high customer satisfaction score.

15. The system of claim 9 wherein providing the instruction comprises imposing a penalty to the business as a result of a low customer satisfaction score.

16. A computer program product comprising a non-transitory computer readable medium including computer-executable instructions that when executed, cause a computer to perform:
receiving a request from a business to sell a product;
negotiating a service level agreement with the business, said service level agreement providing conditions of the sale of the product, said conditions comprising:
terms related to an expected level of quality of the product;
an expected level of efficiency in provision of the product; and
an amount of payment the business can ultimately receive from the sale of the product based on a reported level of quality;
receiving customer feedback on the group buying experience;
computing at least one customer satisfaction score for the group buying experience, wherein said customer satisfaction score represents a degree of customer satisfaction;
mapping the at least one customer satisfaction score to at least one term in the service level agreement; and
providing an instruction related to the customer satisfaction score.

17. The computer program product of claim 16 further comprising:
activating an interface for customers to provide feedback on the group buying experience.

18. The computer program product of claim 17 wherein questions provided in the interface are mapped to terms in the service level agreement.

19. The computer program product of claim 17 wherein the instructions comprise imposing a penalty on the business as a result of a low customer satisfaction score.

20. The computer program product of claim 17 further comprising receiving a security deposit from the business as part of the service level agreement, said security deposit retained to provide a refund to a customer when necessary.
